(19) United States
(12) Patent Application Publication
(10) Pub. No.: US 2006/0111834 A1
(43) Pub. Date: May 25, 2006

(54) Process for selecting outstanding points in an itinerary

(76) Inventors: Loic Bouget, Rennes (FR); Jean-Michel Magret, Thorign-Fouillard (FR); Patrick Gioia, Rennes (FR)

Correspondence Address: MILES & STOCKBRIDGE PC, 1751 PINNACLE DRIVE, SUITE 500, MCLEAN, VA, 22102-3833, US

(21) Appl. No.: 11/252,874

(22) Filed: Oct. 19, 2005

(30) Foreign Application Priority Data
Oct. 20, 2004 (FR) 04 11164

(51) Int. Cl. G01C 21/34

(52) U.S. Cl. 701/201; 701/26; 701/202; 705/6

(57) ABSTRACT

The invention relates to a guiding process comprising the stages of:
generating (106) an itinerary between starting and finishing points; generating guiding instructions including:
   the establishing (107) of several outstanding points close to a part of the itinerary taken from a database (2);
   the calculating (107) of an index representative of the visibility of outstanding points established from said part of the itinerary;
   the selecting (107) of at least one outstanding point according to the index of visibility;
   the generating (108) of guiding instructions associated with a selected outstanding point.

The invention relates to guiding processes and in particular to the generating of itineraries taking into account outstanding points.

To head to a known destination, several processes are known of. According to a first process, the user transmits a request to obtain the itinerary for the known destination. A system receives the request and localises the user. The localisation is either performed automatically (for example by means of a GPS device) or manually by the user (for example by means of the computer keyboard connected to the system). The system calculates the itinerary by using a database and establishes a road plan notably indicating the junctions to take. The system renders the road plan to the user either beforehand or in real time in the form of directions. However, the road plan only mentions the road signs (signposts, road markings, traffic lights . . . ) which can not always be seen by the user. It is therefore frequent that in situ a route mentioned on the road plan is not identified at a junction where the user is.

In order to provide the user with further information a second process for establishing itineraries inserts references at outstanding points on the road plan, for example monuments. Such a process is notably disclosed in the application FR-2 851 042 under the name of the applicant. Outstanding points are recorded in a database and are mentioned on the road plan if the calculated itinerary passes nearby. Information related to the itinerary or the outstanding points are rendered either in the form of directions or in the form of a map. An outstanding point is for example identified by a specific symbol on the map of by a vocal instruction.

The invention aims at improving such a guiding process. There is therefore a need for a guiding process that comprises the stages of:
generating an itinerary between starting and finishing points;
generating guiding instructions including:
   the establishing of several outstanding points close to a part of the itinerary taken from a database;
   the calculating of an index representative of the visibility of outstanding points established from said part of the itinerary;
   the selecting of at least one outstanding point according to the index of visibility;
   the generating of guiding instructions associated with a selected outstanding point.

According to an alternative, the index of visibility is calculated from at least two different types of parameter.

According to another alternative, the calculation of the index of visibility takes into account the parameters chosen from the set comprising the speed of the user, his means of transportation, his sex, his age, a minimum distance between him and the outstanding point, the angle between the direction he is heading and a surface of the outstanding point, the size, the colour or the shape of the outstanding point.

According yet again to an alternative, a road plan, associated with a generated itinerary, is established and includes the guiding instructions associated with a selected outstanding point. The road plan is for example registered in a document.

According to yet another alternative, a new itinerary between the starting and finishing points is generated according to at least one outstanding point selected according to its index of visibility; a road plan associated with the new itinerary is generated and includes the information associated with the selected outstanding point.

According yet again to an alternative, the new itinerary is generated so as to increase the index of visibility of the outstanding point selected from the new itinerary.

According to another alternative, the process further comprises the stages of:
the localisation of a user using a generated itinerary;
the rendering of guiding instructions to the user as he approaches a selected outstanding point.

According to yet another alternative, the index of visibility of an outstanding point is calculated when the user is located in a given perimeter taking into account this outstanding point. The guiding instructions can be rendered vocally or visually.

According to an alternative, an outstanding point is selected when its index of visibility exceeds a pre-set threshold.

According to another alternative, for said part of the itinerary, a pre-set maximum number of outstanding points with the highest index of visibility is selected.

The invention also relates to a computer program capable of implementing such a process.

The invention further relates to a guiding server, which comprises:
means for accessing a database of outstanding points;
a processor configured to generate an itinerary between the starting and finishing points and configured to generate guiding instructions by establishing several outstanding points nearby a part of the itinerary drawn from a database, by calculating an index representative of the visibility of the outstanding points established from said part of the itinerary, by selecting at least one outstanding point according to the index of visibility and by generating a guiding instruction associated with the selected outstanding point;
means for transmitting the generated itinerary to the terminal of a user.

The invention will become clearer upon reading the following description, accompanied with the annexed figures which represent:

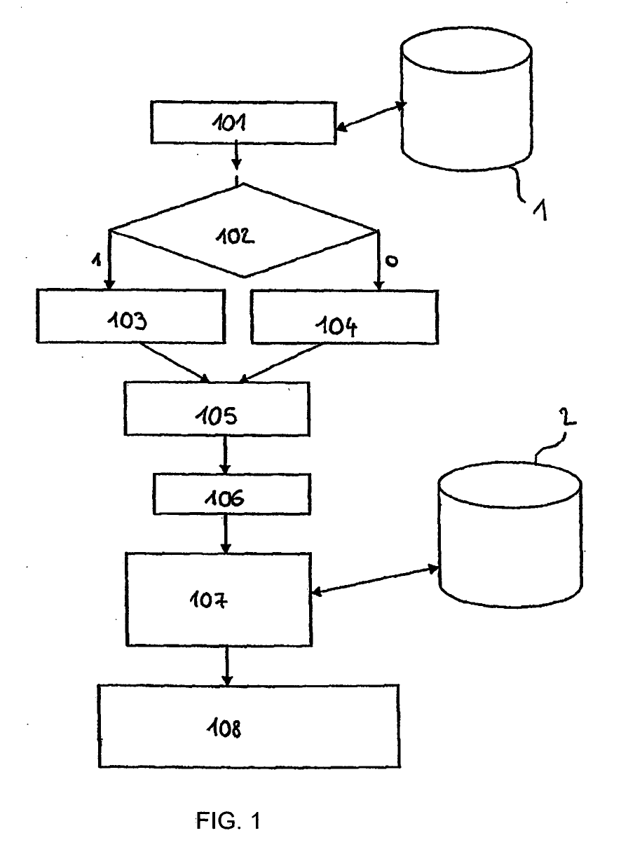

FIG. 1, a flowchart of a process for generating a road plan made prior to taking the itinerary;

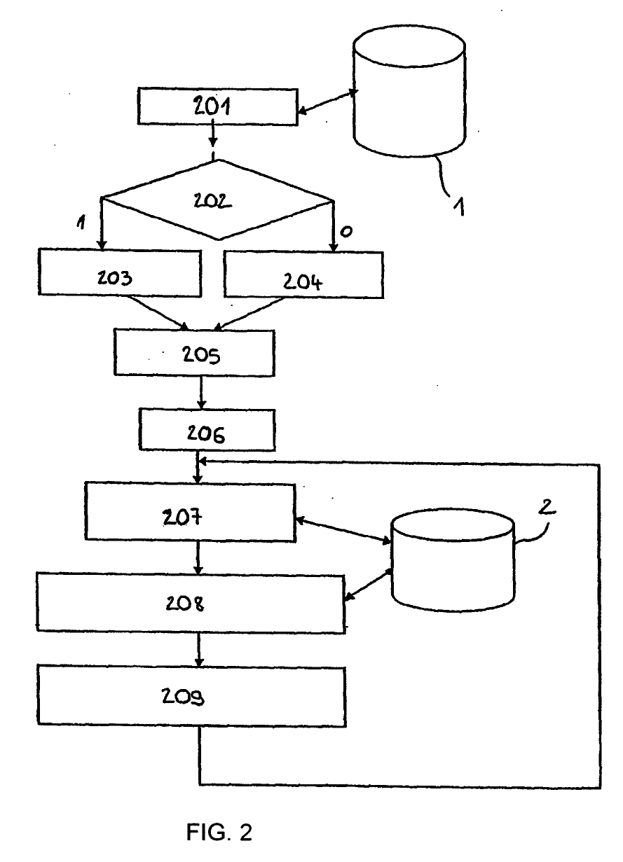

FIG. 2, a flowchart of a process for guiding in real time;

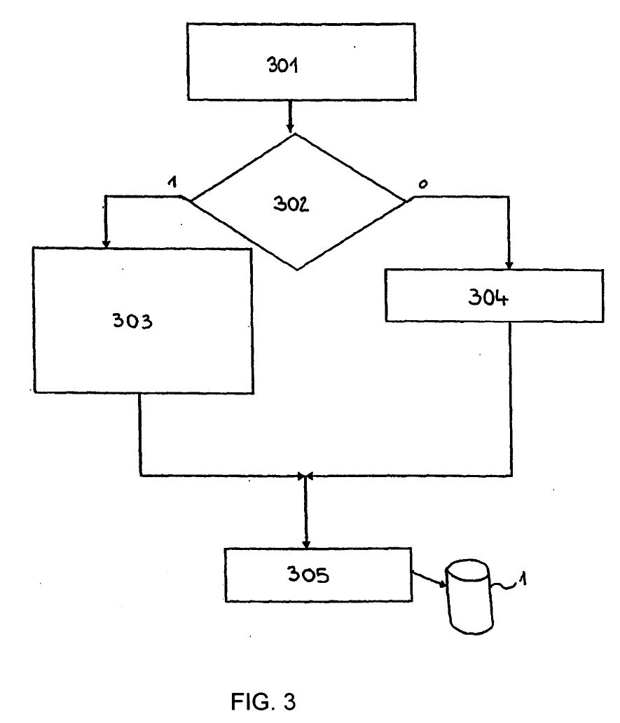

FIG. 3, a flowchart of a process for recording a user profile employed to calculate an index of visibility;

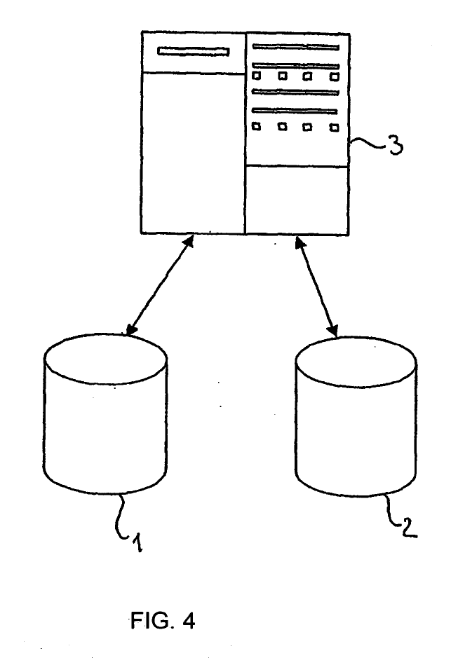

FIG. 4, a diagrammatic representation of a server allowing to implement the process illustrated in FIG. 2.

The expression POI (point of interest) will now be used to designate an outstanding point.

The invention proposes to establish outstanding points near a part of the itinerary, then calculate an index representative of their visibility from this part of the itinerary. An outstanding point is selected according to its index of visibility, then a guiding instruction associated with this outstanding point is generated.

The selecting of an outstanding point is therefore done according to an objective parameter other than its distance to a part of the itinerary. The index of visibility also allows to adjust the selection level of outstanding points. The index of visibility is advantageously calculated from several different types of parameter.

FIG. 1 illustrates an embodiment of the invention in which a road plan is established beforehand by a user connected to a navigation server 3 (illustrated in FIG. 4).

At stage 101, the navigation server 3 loads a profile associated with the user. This profile is advantageously recorded in a database 1 of users that the server 3 can access.

To avoid the user having to input his localisation, at stage 102, the server advantageously establishes if the user can be automatically localised, for example by means of a GPS or any other capable means. If affirmative, the user is automatically localised at stage 103 and his position is assimilated to the starting point. If negative, the server requests a starting point from the user at stage 104.

At stage 105, the server requests the finishing point from the user. At stage 106 the server generates in a known manner an itinerary from the starting and finishing points.

At stage 107, a set of POI near a part of the itinerary (for example a point or section of the itinerary) are established. An index of visibility of these POI from this part of the itinerary is then calculated. To do so, the localisation as well as the parameters of the POI used in the calculation of the index of visibility are recuperated by the server 3 from the database 2. These parameters are for example held in a user location server , in a directory server or in a tourist guide server. Advantageously, a number of predefined POI with the highest index of visibility level is then selected. The density of POI selected for a given part of the itinerary can therefore be limited.

At stage 108, a road plan is established and includes guiding instructions associated with the selected POI and with the generated itinerary. The road plan is recorded in a document, for example in the form of a map or a list of instructions, on paper, in an HTML, JPEG or text file.

FIG. 2 illustrates an embodiment of the invention in which a road plan is established and then completed in real time for a user travelling along an itinerary.

Stages 201 to 209 correspond to the establishing of an initial road plan and can be replaced by stages 101 to 106.

At stage 201, a navigation device (not illustrated) loads a profile associated with the user. This profile is advantageously recorded in the database 1 that the navigation device can access.

At stage 202, the navigation device advantageously establishes if the user can be automatically localised. If affirmative, the user is automatically localised at stage 203 and his position is assimilated to the starting point. If negative, the navigation device requests a starting point from the user at stage 204.

At stage 205, the navigation device requests the finishing point from the user. At stage 206, the navigation device generates an itinerary in a known manner from the starting and finishing points.

At stage 207, a set of POI near a part of the itinerary that the user encounters are established. At stage 208, the index of visibility of these POI from this part of the itinerary is calculated, by using the databases 1 and 2. The index of visibility calculation advantageously takes into account the displacement speed and position of the user in real time, in order to obtain a result that is more appropriate to the navigation context of the user. POI with an index of visibility higher than the predefined threshold are then selected.

At stage 209, the road plan is completed in order to include the guiding instructions associated with the selected POI extracted from the database 2. Stage 207 to 209 are performed periodically along the itinerary taken by the user, for example each time a new position is transmitted by the user.

A navigation device integrated into a vehicle can be envisaged. A navigation device with access to the databases of a remote server can also be envisaged. A remote user navigation device that transmits guiding instructions to a user terminal can also be envisaged.

Examples of index of visibility calculations will be detailed below.

For this reason, the following sets will consequently be used:
ITI: set of itineraries;
Seg2D: set of 2D segments belonging to an itinerary of the ITI set;
Pt2D: set of 2D points belonging to one of the 2D segments of the Seg2D set;
TypPOI: set of possible types of POI.

The following functions will consequently be used:
1(x): x being a real number,
   l(x)_{[x1,x2]}=1<=>x ε[x1,x2]
   l(x)_{[x1,x2]}=0<=>x ∉[x1,x2]
T: T is applied to a POI and transmits its type of POI included in the TypPOI set.
MinDis: this function is applied to a type of POI and transmits the minimum distance from where a POI of the same type is to be taken into account.
MaxDis: this function is applied to a type of POI and transmits the maximum distance from where a POI of the same type must not be taken into account.
Dis: this function transmits the Euclidean distance between a POI and an observation position.
MinVis: this function is applied to a type of POI and transmits the minimum index of visibility required for this type of POI. The value transmitted by MinVis is therefore between 0 and 1.
MaxVis: this function is applied to a type of POI and transmits the maximum index of visibility required for this type of POI. The real value transmitted by MaxVis is therefore between 0 and 1.
Vis3D: for a POI and a given part of the itinerary (an itinerary, a segment or a point), this function transmits an index of visibility of the POI from a part of the itinerary. The real value transmitted by Vis3D is between 0 and 1.
ValiditePoi: the arguments of this function are the type of a POI, the distance Dist between this POI and a part of the itinerary, and the index of visibility Vis3D of the POI from this part of the itinerary. This function transmits a binary value to select or not select a POI.
   ValiditePoi (t, Dist, Vis3D)=l(Dist)_{[MinDis(t),MaxDis(t)]}*l(Vis3D)_{[MinVis(t),MaxVis(t)]}
CoutVis: this function provides an improved index of visibility of a POI compared to the user data and to the itinerary. In this embodiment, the index of visibility takes into account the visibility percentage of the POI. Let P be a POI with a remarkable plane surface, pos be the position of an observer, α be the angle between p and pos (angle between the vectors n and v, n being a vector defining the normal to the remarkable surface, v being a vector defining the direction of the observer). CoutVis is defined as follows:

$$CoutVis ( p , pos , α ) = \frac{\begin{matrix}ValiditePoi ( T ( p ) , Dis ( p , pos ) , Vis3 D ( p , pos ) ) * \\ Vis3 D ( p , pos ) * / cos α / \end{matrix}}{{Dis ( p , pos )}^{2}}$$

The use of angles and remarkable plane surfaces can be as follows: for a given POI, the surfaces that are visually identifiable by a user are established. For a hotel, all the signs and show plates located on the building and bearing the title “Hotel” or the name of the hotel for example are selected. These surfaces will be used as references of visibility. Indeed, someone in the vicinity of the building will identify the building by means of a show plate with greater ease compared to any one of the buildings surfaces. In the previous formulae, the expression |cos α| is advantageously replaced by cos α. Thus, for a billboard, we deduce from a positive index of visibility whether the user is facing away from or behind the billboard, and that the latter is therefore invisible. The index of visibility advantageously takes into account the ratio between the appearance of such a surface and its distance from the user. The index of visibility advantageously takes into account the colour or shape of the surface or of the POI.

The index of visibility is advantageously defined according to the speed of the user. Smaller objects could prove to be hardly visible beyond a given speed. The momentary speed of the user could for example be taken into account for a guiding application in real time. A supposed or user set speed for given types of itinerary will also preferably be taken into account for the prior establishment of a road plan.

The index of visibility can also be defined according to the type of means of transport used to cover the itinerary (bicycle, foot, motor vehicle . . .).

The index of visibility can be defined not only from parameters of the itinerary and of the POI but also from parameters related to the user. These parameters are for example recorded in a profile in the database 1 or defined by the user or by an appropriate process at the time of generating the itinerary. A function establishing the visibility of a POI can notably take into account the age, sex, maximum focal distance, minimum focal distance of the user.

Known in itself, the POI can be indicated to the user in the form of guiding instructions. These orders can be recorded on a road plan or rendered vocally or visually in real time whilst the user is travelling, approaching a POI.

Moreover, the creation of a new itinerary can be envisaged based on the generated initial itinerary and the selected POI. Indeed, once the POI have been selected a new itinerary can be generated bearing parts in which the index of visibility of the POI has increased. The index of visibility can therefore be taken into account for generating an itinerary. The user can also discard selected POI or add desired POI in order to generate the new itinerary.

FIG. 3 illustrates an example of the process for recording a user profile. At stage 301, the user connects to a registration server within a navigation server. For example, the user will provide access identifications or fill out a registration form. At stage 302, the server requests if the user wishes to add criterion for the calculating of the index of visibility.

If the user replies positively, then the server will request, at stage 303, that certain parameters be detailed, for example the type of POI that can be selected (hotels, monuments, billboards . . . ), the minimum and maximum distance to be taken into account for a POI relatively to a part of the itinerary, the optimal distance of visibility of a POI . . .

If the user replies negatively, then an application of the server will, by default, establish these parameters at stage 304. This default establishment is for example performed from personal information provided by the user: means of transport, age, sex . . .

During stage 305, the thus obtained parameters are recorded in the database 1 so that they can be used at a later stage for calculating the index of visibility of the POI.

1. Guiding process comprising the stages of:
generating (106) an itinerary between starting and finishing points;
generating guiding instructions including:
the establishing (107) of several outstanding points close to a part of the itinerary taken from a database (2);
characterized in that the generating of guiding instructions further include:
the calculating (107) of an index representative of the visibility of outstanding points established from said part of the itinerary;
the selecting (107) of at least one outstanding point according to the index visibility;
the generating (108) of guiding instructions associated with a selected outstanding point.

2. Guiding process according to claim 1, characterised in that the index of visibility is calculated from at least two different types of parameter.

3. Guiding process according to claim 1, characterised in that the calculation of the index of visibility takes into account the parameters chosen from the set comprising the speed of the user, his means of transportation, his sex, his age, a minimum distance between him and the outstanding point, the angle between the direction he is heading and a surface of the outstanding point, the size, the colour or the shape of the outstanding point.

4. Guiding process according to claim 1, characterised in that a road plan, associated with a generated itinerary, is established and includes the guiding instructions associated with a selected outstanding point.

5. Guiding process according to claim 1, characterised in that:
a new itinerary between the starting and finishing points is generated according to at least one outstanding point selected according to its index of visibility;
a road plan associated with the new itinerary is generated and includes the information associated with the selected outstanding point.

6. Guiding process according to claim 5, characterised in that the new itinerary is generated so as to increase the index of visibility of the outstanding point selected from the new itinerary.

7. Guiding process according to claim 1, characterised in that it further comprises the stage of:
the localisation of a user using a generated itinerary;
the rendering of guiding instructions to the user as he approaches a selected outstanding point (209).

8. Guiding process according to claim 7, characterised in that the index of visibility of an outstanding point is calculated (208) when the user is located in a given perimeter taking into account this outstanding point.

9. Guiding process according to claim 1, characterised in that an outstanding point is selected when its index of visibility exceeds a pre-set threshold.

10. Guiding process according to claim 1, characterised in that, for said part of the itinerary, a pre-set maximum number of outstanding points with the highest index of visibility is selected.

11. Computer program stored on a tangible medium and configured to implement the process of claim 1.

12. Guiding server (3), characterized in that it comprises:
means for accessing a database of outstanding points;
a processor configured to generate an itinerary between the starting and finishing points and configured to generate guiding instructions by establishing several outstanding points nearby a part of the itinerary drawn from a database, by calculating an index representative of the visibility of the outstanding points established from said part of the itinerary, by selecting at least one outstanding point according to the index of visibility and by generating a guiding instruction associated with the selected outstanding point;
means for transmitting the generated itinerary to the terminal of a user.
